(19) United States
(12) Patent Application Publication
(10) Pub. No.: US 2026/0056839 A1
(43) Pub. Date: Feb. 26, 2026

(54) MEMORY SYSTEM, MEMORY CONTROLLER, AND CONTROL METHOD

(71) Applicant: Kioxia Corporation, Tokyo (JP)

(72) Inventors: Yu SATO, Yokohama (JP); Yuta KUMANO, Kawasaki (JP)

(73) Assignee: Kioxia Corporation, Tokyo (JP)

(21) Appl. No.: 19/077,499

(22) Filed: Mar. 12, 2025

(30) Foreign Application Priority Data
Aug. 23, 2024 (JP) 2024-142683

(51) Int. Cl. G06F 11/10

(52) U.S. Cl. CPC G06F 11/1068; G06F 11/1048

(57) ABSTRACT

A memory system includes a nonvolatile memory and a memory controller. The nonvolatile memory stores a concatenated code including a first error correction code and a second error correction code. The memory controller performs, for read information read from the nonvolatile memory, second decoding processing with the second error correction code; if decoding in the second decoding processing fails, performs, for the read information reflecting a correction result of the second decoding processing, first decoding processing with the first error correction code; if decoding in the first decoding processing fails, identifies an intersection of component codes that are in two or more respective different dimensions of the second error correction code and each include an error; and performs modification processing for modifying a symbol in the intersection and further performs the first decoding processing.

### CROSS-REFERENCE TO RELATED APPLICATION

This application is based upon and claims the benefit of priority from Japanese Patent Application No. 2024-142683, filed Aug. 23, 2024, the entire contents of which are incorporated herein by reference.

### FIELD

Embodiments described herein relate generally to a memory system, a memory controller, and a control method.

### BACKGROUND

In a memory system, to protect data stored in a memory such as a NAND-type flash memory, the data is encoded with error correction and stored in the memory. As such, when reading the data stored in the memory, the error-correction-encoded data (also called a received word) read from the memory is decoded to recover the data in the form not encoded with error correction.

### BRIEF DESCRIPTION OF THE DRAWINGS

FIG. 1 is a block diagram of a memory system according to a first embodiment.

FIG. 2 is a diagram illustrating an example of an outer code and an inner code.

FIG. 3 is a diagram illustrating an example of a situation in which errors cannot be eliminated.

FIG. 4 is a block diagram of a decoder in the first embodiment.

FIG. 5 is a diagram illustrating an example of successful decoding.

FIG. 6 is a flowchart of decoding processing in the first embodiment.

FIG. 7 is a diagram illustrating an example of an error occurrence situation.

FIG. 8 is a flowchart of decoding processing in a third embodiment.

FIG. 9 is a diagram illustrating an example in which all patterns can be attempted.

### DETAILED DESCRIPTION

An object of embodiments of the present invention is to provide a memory system, a memory controller, and a control method that enable performing more accurate error correction (decoding).

In general, according to one embodiment, a memory system includes: a nonvolatile memory that stores a concatenated code including a first error correction code and a second error correction code; and a memory controller. The memory controller performs, for read information read from the nonvolatile memory, second decoding processing with the second error correction code; if decoding in the second decoding processing fails, performs, for the read information reflecting a correction result of the second decoding processing, first decoding processing with the first error correction code; if decoding in the first decoding processing fails, identifies an intersection of component codes that are in two or more respective different dimensions of the second error correction code and each include an error; and performs modification processing for modifying a symbol in the intersection and further performs the first decoding processing.

With reference to the accompanying drawings, a memory system according to embodiments will be described in detail below. It is to be noted that the following embodiments are not intended to limit the present invention.

### First Embodiment

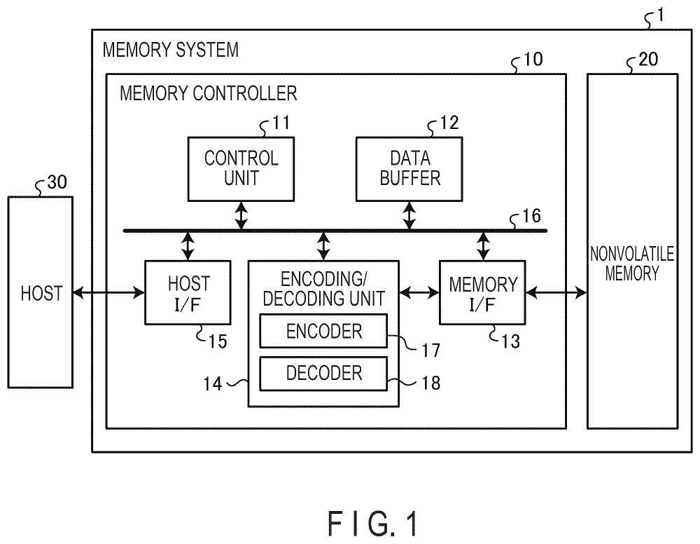

FIG. 1 is a block diagram illustrating an exemplary schematic configuration of a memory system according to a first embodiment. As shown in FIG. 1, the memory system 1 includes a memory controller 10 and a nonvolatile memory 20. The memory system 1 can connect to a host 30, and is shown connected to the host 30 in FIG. 1. The host 30 may be, for example, an electronic device such as a personal computer or a mobile terminal.

The nonvolatile memory 20, for example a NAND memory, stores data in a nonvolatile form. Although the following description illustrates the use of a NAND memory as the nonvolatile memory 20, the nonvolatile memory 20 may be a storage device different from a NAND memory, such as a three-dimensionally structured flash memory, a resistance random access memory (ReRAM), or a ferroelectric random access memory (FeRAM). The nonvolatile memory 20 need not necessarily be a semiconductor memory, and this embodiment is applicable to various storage media other than semiconductor memories.

The memory system 1 may be a memory card that integrates the memory controller 10 and the nonvolatile memory 20 into a single package, or may be a solid state drive (SSD).

The memory controller 10 controls writing to the nonvolatile memory 20 according to write requests from the host 30. The memory controller 10 also controls reading from the nonvolatile memory 20 according to read requests from the host 30. The memory controller 10 includes a host interface (host I/F) 15, a memory interface (memory I/F) 13, a control unit 11, an encoding/decoding unit (codec) 14, and a data buffer 12. The host I/F 15, the memory I/F 13, the control unit 11, the encoding/decoding unit 14, and the data buffer 12 are interconnected via an internal bus 16. Some or all of the operations of the components of the memory controller 10 may be implemented by a central processing unit (CPU) executing firmware, or by hardware. In some implementations, memory controller 10 may comprise circuitry or processing circuitry which includes general purpose processors, special purpose processors, integrated circuits, ASICs (“Application Specific Integrated Circuits”), FPGAs (“Field-Programmable Gate Arrays”), and/or combinations thereof which are programmed, using one or more programs stored in one or more memories, or otherwise configured to perform the disclosed functionality. Processors and controllers are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

The host I/F 15 is a circuit that performs processing compliant with an interface standard adopted between the host I/F 15 and the host 30 and that outputs, to the internal bus 16, instructions and to-be-written user data received from the host 30. The host I/F 15 also transmits, to the host 30, user data that has been read from the nonvolatile memory 20 and recovered, as well as responses from the control unit 11.

The memory I/F 13 is a circuit that performs processing of writing to the nonvolatile memory 20 based on instructions from the control unit 11. The memory I/F 13 also performs processing of reading from the nonvolatile memory 20 based on instructions from the control unit 11.

The control unit 11 is a circuit that centrally controls the components of the memory system 1. The control unit 11, in response to instructions received from the host 30 via the host I/F 15, performs control according to the instructions. As an example, according to an instruction from the host 30, the control unit 11 instructs the memory I/F 13 to write user data and parity bits to the nonvolatile memory 20. As another example, according to an instruction from the host 30, the control unit 11 instructs the memory I/F 13 to read user data and parity bits from the nonvolatile memory 20.

Upon receiving a user data write request from the host 30, the control unit 11 holds the user data in the data buffer 12 and determines a storage area (memory area) in the nonvolatile memory 20 for storing the user data. That is, the control unit 11 manages the write destination of the user data. An address conversion table is stored, indicating correspondences between the logical addresses of user data items received from the host 30 and the physical addresses indicating the storage areas in the nonvolatile memory 20 in which the user data items are stored.

Upon receiving a read request from the host 30, the control unit 11 uses the above address conversion table to convert a logical address specified in the read request into a physical address and instructs the memory I/F 13 to perform reading from the physical address.

In a NAND memory, data is typically written and read in data units called pages, and erased in data units called blocks. In this embodiment, memory cells connected to the same word line are referred to as a memory cell group. If the memory cells are single-level cells (SLCs), one memory cell group corresponds to one page. If the memory cells are multi-level cells (MLCs), one memory cell group corresponds to multiple pages. Each memory cell is connected to a word line and also to a bit line. Each memory cell can thus be identified by an address indicating the word line and an address indicating the bit line.

The data buffer 12 temporarily stores user data received by the memory controller 10 from the host 30 until the user data is stored in the nonvolatile memory 20. The data buffer 12 also temporarily stores user data read from the nonvolatile memory 20 until the user data is transmitted to the host 30. The data buffer 12 may be, for example, a general-purpose memory such as a static random access memory (SRAM) or a dynamic random access memory (DRAM).

User data transmitted from the host 30 is transferred to the internal bus 16 and temporarily stored in the data buffer 12. The encoding/decoding unit 14 encodes the user data to generate a codeword. The encoding/decoding unit 14 also decodes a received word, which is data read from the nonvolatile memory 20, to recover user data. For these purposes, the encoding/decoding unit 14 includes an encoder 17 and a decoder 18. In some embodiments, encoder 17 includes an encoding circuit and decoder 18 includes a decoding circuit and in other embodiments encoder 17 and decoder 18 share a circuit. In addition to user data, data encoded by the encoding/decoding unit 14 may include control data for use in the memory controller 10.

Write processing in this embodiment will be described. To write user data to the nonvolatile memory 20, the control unit 11 instructs the encoder 17 to encode the user data. The control unit 11 also determines a memory location (memory address) in the nonvolatile memory 20 at which a codeword is to be stored, and instructs the determined memory location to the memory I/F 13.

Based on the instruction from the control unit 11, the encoder 17 encodes the user data in the data buffer 12 to generate a codeword. Exemplary encoding schemes that may be used include schemes using algebraic codes such as Bose-Chaudhuri-Hocquenghem (BCH) codes and Reed-Solomon (RS) codes, as well as schemes using these codes as component codes in the row and column directions (such as product coding). The memory I/F 13 controls storing the codeword in the memory location in the nonvolatile memory 20 instructed by the control unit 11.

Read processing for reading from the nonvolatile memory 20 in this embodiment will be described. To read data from the nonvolatile memory 20, the control unit 11 specifies an address in the nonvolatile memory 20 and instructs the memory I/F 13 to read the data. The control unit 11 also instructs the decoder 18 to start decoding. The memory I/F 13, according to the instruction from the control unit 11, reads the data from the specified address in the nonvolatile memory 20 and inputs the read data as a received word to the decoder 18. The decoder 18 decodes the received word, i.e., the data read from the nonvolatile memory 20.

Now, an error correction code (a codeword) used in this embodiment will be described. In this embodiment, the encoder 17 generates a concatenated code as an error correction code. For example, the concatenated code includes an error correction code C1 (a first error correction code) generated with data (user data) to be stored in the nonvolatile memory 20, and an error correction code C2 (a second error correction code) generated with the error correction code C1. Hereinafter, the error correction code C1 will be referred to as an outer code, and the error correction code C2 will be referred to as an inner code.

The outer code is used to eliminate errors (remaining errors) left uncorrected by error correction with the inner code. An example of the outer code may be a 4-bit-correctable BCH code. Decoding with the outer code (remaining-error elimination) may cause miscorrection and thus may involve determination processing for determining whether erroneous correction has occurred. An example of the inner code may be a multidimensional error correction code.

Here, the multidimensional error correction code refers to an error correction code in which at least one of the symbols constituting the code is multi-protected by multiple smaller component codes. One symbol corresponds to, for example, 1 bit (an element in a binary field), or an alphabetical element in a finite field different from a binary field. For ease of description, the following takes an example of a binary-field error correction code in which one symbol corresponds to one bit. Portions of the following description may refer to Symbol and bit, although both have the same meaning.

An example of the multidimensional error correction code is a product code. For example, a product code may have a structure in which the information symbols constituting user data are each protected in the row direction and the column direction by BCH codes, each including parity symbols of a predetermined parity length. That is, in a product code, every symbol is double-protected by a component code in the row direction (referred to as dimension 1) and a component code in the column direction (referred to as dimension 2). It is to be noted that the multidimensional error correction code is not limited to such a structure and may be a generalized low density parity check (LDPC) code, for example. In general multidimensional error correction codes including generalized LDPC codes, the multiplicity of protection may differ among symbols, and the component codes cannot be divided into groups such as dimension 1 and dimension 2. However, the present technique is also applicable to such code configurations.

For simplicity, the following description takes an example of using a two-dimensional error correction code (product code) in which each symbol is protected by two component codes that can be grouped into dimension 1 and dimension 2, respectively. The component codes in each dimension includes one or more component codes, the number of component codes being specified per dimension. Hereinafter, the component codes corresponding to each dimension and including one or more component codes may be referred to as a component code group. For example, the component code group in dimension 1 includes n1 component codes, and the component code group in dimension 2 includes n2 component codes. Error correction codes that can be used are not limited to the above and may be an N-dimensional (N is an integer greater than 1) error correction code in which at least one of the symbols constituting the code is protected by N component code groups. In terms of the number of component codes in each component code group, an N-dimensional error correction code is protected by M component codes (M is the total sum of ni (1≤i≤N), N is an integer greater than 1, and ni is the number of component codes in the i-th dimension).

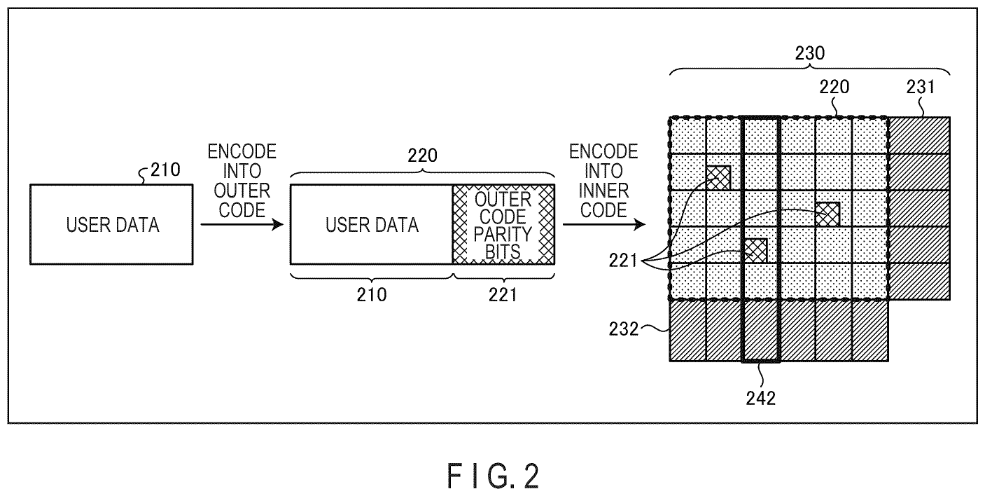

With reference to FIG. 2, an example of the outer code and the inner code will be described. FIG. 2 illustrates an example in which the inner code used is a two-dimensional-block product code with five blocks in the row direction and six blocks in the column direction. Each block includes multiple symbols constituting a code. Each block corresponds to a symbol group that is a set of symbols constituting a code. The number of blocks in each direction is not limited to the example shown in FIG. 2. For example, subsequent diagrams may illustrate the inner code as a two-dimensional-block product code with four blocks in each of the row and column directions.

As shown in FIG. 2, first, the encoder 17 encodes user data 210 into an outer code 220. The outer code 220 includes the user data 210 and outer code parity bits 221. The encoder 17 then encodes the outer code 220 into an inner code 230. The inner code 230 includes the outer code 220, parity blocks 231 in the row direction of the inner code, and parity blocks 232 in the column direction of the inner code.

The inner code is, for example, a two-dimensional-block product code having 3-bit-correctable BCH codes as its component codes. In the example in FIG. 2, the 3-bit-correctable BCH codes are the five component codes in the row direction (dimension 1) and the six component codes in the column direction (dimension 2).

The outer code can be used to do the following:
Eliminate errors (remaining errors) left uncorrected by the inner code.
Determine whether errors are remaining in the user data; if no errors are remaining, the decoding is regarded as success and the processing is terminated.

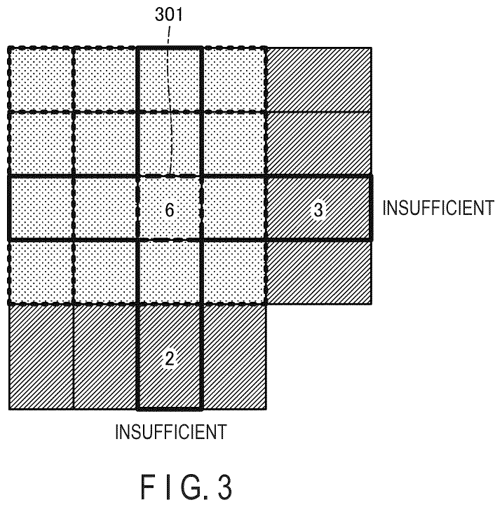

Error patterns may arise such that errors cannot be eliminated even with the outer code and cause an error floor. FIG. 3 is a diagram illustrating an example of a situation in which errors cannot be eliminated even with the outer code.

The example in FIG. 3 assumes that, as illustrated above, the inner code is a product code having 3-bit-correctable BCH codes as its component codes, and the outer code is a 4-bit-correctable BCH code. The numerical values in FIG. 3 each represent the number of errors in the corresponding block. It is to be noted that, instead of the BCH codes, RS codes may be used for the inner code and the outer code.

For example, six errors are included in an intersection 301, which is the block at the intersection of the component code in the third row and the component code in the third column (the block included in both of these component codes). Because the number of errors in the intersection 301 exceeds the number of correctable errors (3 bits) of the component codes, the component codes in the third row and the third column provide unsatisfied syndromes. Furthermore, because the number of errors in the intersection 301 exceeds the number of correctable errors (4 bits) of the outer code, the errors cannot be eliminated even with the outer code. Thus, in a situation in which errors concentrate in one intersection, the errors cannot be eliminated even with the outer code.

Such situations may arise when, for example, an outer code with a reduced correction capability is used for improving the entire decoding performance. This embodiment enables accurate error correction (decoding) in such situations.

This embodiment is directed to a case in which there is only one intersection such that relevant component codes in the respective dimensions each include errors (hereinafter referred to as an error intersection). A second embodiment will describe an example directed to a case in which the number of error intersections is smaller than or equal to a threshold (a number threshold) that is two or more.

In this embodiment, if decoding with the outer code fails and only one error intersection is identified, the decoding with the outer code is further performed by inverting (flipping) the values of bits in the error intersection. For this purpose, a technique such as multi-bit flip decoding (MBFD) may be applied, for example.

The inversion processing of inverting bit values can reduce the errors in the error intersection to the number smaller than or equal to the number of errors correctable by the outer code. As the number of inverted bits (the number of inversions) increases, the correction is more likely to succeed but with an increased processing amount. It is therefore desirable to determine the number of inversions based on factors such as the correction ability of the outer code, the block size, and the allowable processing amount.

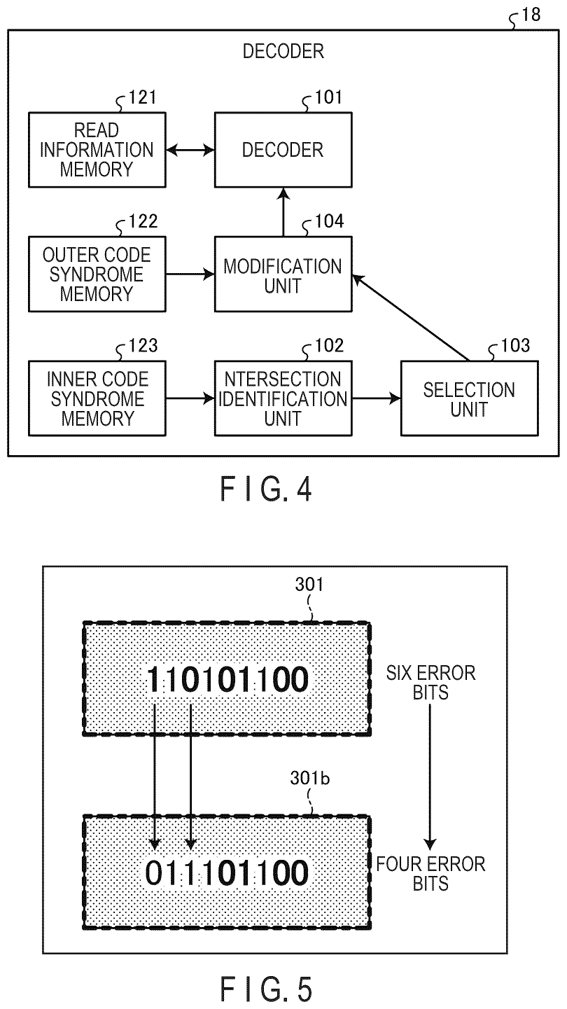

Now, an exemplary configuration of the decoder 18 will be described. FIG. 4 is a block diagram illustrating an exemplary schematic configuration of the decoder 18 in the first embodiment. As shown in FIG. 4, the decoder 18 includes a read information memory 121, an outer code syndrome memory 122, an inner code syndrome memory 123, a decoder 101, an intersection identification unit 102, a selection unit 103, and a modification unit 104.

The read information memory 121 is implemented by an SRAM, for example. The outer code syndrome memory 122 and the inner code syndrome memory 123 are each implemented by a register, for example. The decoder 101, the intersection identification unit 102, the selection unit 103, and the modification unit 104 are each implemented by at least one of a register, an adder, a multiplier, and other arithmetic elements. The register is implemented by a logical circuit such as a flip-flop, for example. The adder, multiplier, selector, and other arithmetic elements are each implemented by a logical circuit, for example.

The read information memory 121 stores read information, which is data read from the nonvolatile memory 20.

The outer code syndrome memory 122 stores a syndrome SD1 of the outer code, calculated in decoding processing DEC1 with the outer code (first decoding processing). The inner code syndrome memory 123 stores multiple syndromes SD2 of multiple component codes, calculated in decoding processing DEC2 with the inner code (second decoding processing). Syndromes are information that can be used to determine whether read information includes an error. For example, if all the syndromes take the value 0, the read information is determined to be error-free.

The decoder 101 performs the decoding processing DEC1 with the outer code, and the decoding processing DEC2 with the inner code. For example, first, the decoder 101 performs, for the read information, the decoding processing DEC2 with the inner code. If the decoding in the decoding processing DEC2 fails, the decoder 101 performs, for the read information that reflects the correction result of the decoding processing DEC2, the decoding processing DEC1 with the outer code. The decoding processing DEC1 is bounded distance decoding, for example. The decoder 101 stores the read information subjected to the two steps of decoding processing in the read information memory 121.

If the decoding processing DEC1 with the outer code fails, the intersection identification unit 102 identifies an intersection of component codes that are in two or more respective different dimensions and each include errors (an error intersection). For a two-dimensional error correction code (product code), an error intersection corresponds to a block for which errors are included in both a component code in the component code group in dimension 1 (the row direction) and a component code in the component code group in dimension 2 (the column direction).

The intersection identification unit 102 identifies the error intersection using feature information indicating the correctness of the correction made with the inner code (the error correction code C2). The feature information is, for example, the syndromes SD2 of the inner code. In this case, the intersection identification unit 102 identifies, as the error intersection, a block for which both the syndrome SD2 of a component code in the row direction and the syndrome SD2 of a component code in the column direction are insufficient.

The feature information is not limited to the syndromes SD2. For example, if the reliability (probability information) indicating the degree of correctness of the result of the correction made with each component code of the inner code (the error correction code C2) is available, the intersection identification unit 102 may use the reliability as the feature information. In this case, for example, the intersection identification unit 102 identifies, as the error intersection, a block for which both the reliability of a component code in the row direction and the reliability of a component code in the column direction are lower than or equal to a threshold (a reliability threshold).

The selection unit 103 selects, from the identified error intersection, one or more bits to be modified. The modification unit 104 performs modification processing for modifying the selected bits. For example, the modification processing is inverting the selected bits. After the modification processing, the decoder 101 further performs the decoding processing DEC1. The above sequence of processing by the selection unit 103, the modification unit 104, and the decoder 101 is repeated until the decoding processing DEC1 succeeds or until all bit modification patterns are attempted.

The processing by the selection unit 103 will be described further. For example, the selection unit 103 determines the number of inversions smaller than or equal to a predetermined maximum value (e.g., 3 bits). The selection unit 103 determines a pattern that includes the determined number of inversions and, according to the determined pattern, selects one or more bits to be modified (inverted) among the bits in the error intersection. Thus, for all the numbers of inversions and all the patterns corresponding to each number of inversions, the selection unit 103 selects bits to be modified until the decoding processing DEC1 succeeds.

For example, if the maximum value is 3 bits, the selection unit 103 determines the number of inversions in the order of 1 bit, 2 bits, and 3 bits. Upon determining the number of inversions to be 1 bit, the selection unit 103 determines any one of the patterns that invert one of the bits in the error intersection. Upon determining a pattern that inverts the first bit, the selection unit 103 selects the first bit. If the decoding processing DEC1 still fails after the selected first bit is modified, the selection unit 103 further determines a pattern that inverts another bit (e.g., the second bit).

If the decoding processing DEC1 still fails after all the patterns that invert 1 bit are attempted, the selection unit 103 determines the number of inversions to be 2 bits and repeats the processing similarly for patterns that invert 2 bits. If the decoding processing DEC1 still fails after all the patterns that invert 2 bits are attempted, the selection unit 103 determines the number of inversions to be 3 bits and repeats the processing similarly for patterns that invert 3 bits. If the decoding processing DEC1 still fails after all the patterns that invert the maximum number of inversions are attempted, the decoding is regarded as failure.

The processing of modifying (inverting) the selected bits and repeating the decoding processing DEC1 may also be implemented by the following processing. First, the decoder 18 generates data of the same size (the same number of elements) as the syndrome SD1 of the outer code, with 1 representing the element(s) corresponding to the selected bit(s) and 0 representing to the other elements. The decoder 18 modifies the syndrome SD1 by exclusively ORing (XORing) the generated data and the unmodified syndrome SD1. Using the modified syndrome SD1, the decoder 18 performs the decoding processing DEC1.

An example of successful decoding in this embodiment will be described. FIG. 5 is a diagram illustrating an example of successful decoding. FIG. 5 corresponds to an example in which errors cannot be eliminated even with the outer code (e.g., FIG. 3) and then the decoding processing DEC1 is performed by inverting bits, resulting in successful decoding.

For example, in this embodiment, failure in the decoding processing DEC1 may cause a situation as illustrated in FIG. 3. The intersection identification unit 102 then uses the syndromes SD2 of the inner code to identify the intersection 301 as an error intersection.

It is assumed that the intersection 301 is of a size of 9 bits. It is further assumed that, as shown in FIG. 5, the intersection 301 includes six error bits: the first, third, fifth, sixth, eighth, and ninth bits. It is also assumed that, according to the pattern that inverts the first and third bits among the patterns that invert 2 bits, the selection unit 103 selects the first and third bits.

The intersection 301b in FIG. 5 illustrates the state after the modification unit 104 modifies the first and third bits selected as above. The intersection 301b includes four error bits: the fifth, sixth, eighth, and ninth bits. Thus, decoding will succeed with the 4-bit-correctable outer code.

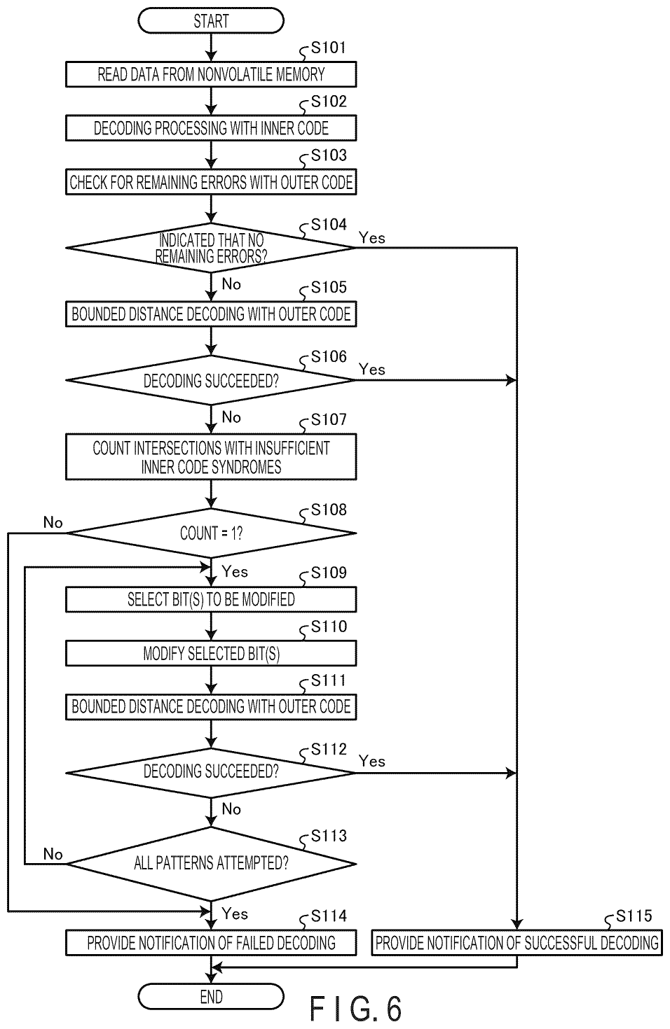

Now, the sequence of decoding processing by the memory system 1 in this embodiment will be described. FIG. 6 is a flowchart illustrating an example of decoding processing in the first embodiment.

The control unit 11 reads an error correction code from the nonvolatile memory 20 to obtain read information (step S101). The control unit 11 transfers the read information to the read information memory 121 to be stored therein.

The decoder 18 performs the decoding processing DEC2 with an inner code (step S102). If the inner code used is a product code as shown in FIG. 2, the decoder 18 performs the decoding processing DEC2 by, for example, alternately repeating decoding the component codes in the row direction (dimension 1) and the component codes in the column direction (dimension 2). In this case, step S102 in FIG. 6 corresponds to decoding the component codes in one dimension (dimension 1 or dimension 2).

Upon completion of the decoding of the component codes in one dimension, the decoder 18 performs check processing with an outer code for checking for remaining errors (step S103). For example, the check processing uses the outer code to check that the read information is error-free (has no remaining errors). The check processing is performed for checking for errors remaining in the user data portion, for example, using means such as the syndrome SD1 of the outer code, as each component code of the inner code is decoded.

The decoder 18 determines whether the result of the check processing (the check result) shows no remaining errors (step S104). If it is determined that the check result does not show no remaining errors (shows remaining errors) (step S104: No), the decoder 18 (the decoder 101) performs bounded distance decoding (the decoding processing DEC1) with the outer code (step S105). The decoder 18 determines whether the decoding in the decoding processing DEC1 succeeds (step S106).

If it is determined that the decoding in the decoding processing DEC1 fails (step S106: No), the intersection identification unit 102 identifies error intersections for which the syndromes of inner codes are insufficient, and counts the identified intersections (step S107).

The decoder 18 determines whether the number of intersections is one (step S108). If the number of intersections is one (step S108: Yes), the selection unit 103 selects, in the error intersection, one or more bits to be modified (step S109). The modification unit 104 performs modification processing for modifying the selected bit(s) (step S110). After the modification processing, the decoder 101 further performs the decoding processing DEC1 (step S111). The decoder 18 determines whether the decoding in the decoding processing DEC1 succeeds (step S112).

If it is determined that the decoding in the decoding processing DEC1 succeeds (step S112: Yes), or if it is determined at step S104 that the check result shows no remaining errors (step S104: Yes), or if it is determined at step S106 that the decoding in the decoding processing DEC1 succeeds (step S106: Yes), the decoder 18 provides notification of successful decoding and a decoded word to a destination such as an external control unit (step S115) and terminates the decoding processing.

If it is determined that the decoding in the decoding processing DEC1 fails (step S112: No), the decoder 18 determines whether all the inversion patterns have been attempted (step S113). If not all the patterns have been attempted (step S113: No), the process returns to step S109 to repeat the processing for a pattern that has not been attempted.

If all the patterns have been attempted (step S113: Yes) or if it is determined at step S108 that the number of intersections is not one (step S108: No), the decoder 18 provides notification of failed decoding to a destination such as an external control unit (step S114) and terminates the decoding processing.

### Second Embodiment

The above first embodiment involves, if the number of error intersections is one, inverting the values of bits in the error intersection and further performing the decoding with the outer code. A second embodiment describes an example for the number of error intersections smaller than or equal to four. This embodiment can be considered an example in which the value of the threshold to be compared with the number of error intersections is 4. The value of the threshold is not limited to 4 and may be any other value. The first embodiment can be considered an example in which the value of the threshold is 1.

In this embodiment, the selection unit 103 selects, in one of up to four error intersections, one or more bits to be modified. Processing for only one identified error intersection is the same as that in the first embodiment. For multiple (two to four) identified error intersections, the selection unit 103 selects one of the error intersections and selects bits from the selected error intersection.

For example, if the correction reliability of each bit is available, the selection unit 103 may use any of the following manners to select an error intersection based on the result of reliability comparison.

The selection unit 103 compares the minimum value of the reliabilities of the bits in each error intersection with each other, and selects the error intersection with the smallest minimum value.

The selection unit 103 compares the sum of a predetermined number of reliabilities in ascending order among the reliabilities of the bits in each error intersection with each other, and selects the error intersection with the smallest sum. The predetermined number may depend on, for example, the maximum value of inversions or the correction ability of the outer code.

The selection unit 103 compares the sum of the reliabilities of all the bits in each error intersection with each other, and selects the error intersection with the smallest sum.

The criterion for the selection is not limited to the reliability and may be any other criterion. If the multiple error intersections are under the same condition, the selection unit 103 may select any of the error intersections. Alternatively, if the multiple error intersections are under the same condition, the selection unit 103 may select bits from each of the error intersections as equally as possible. The selection unit 103 may also select bits from each of the multiple error intersections in a manner that the number of selected bits are weighted according to the reliability of each error intersection calculated as above (such as the minimum reliability, the sum of a predetermined number of reliabilities, or the sum of the reliabilities of all the bits).

The decoding processing in this embodiment can be implemented by, for example, modifying the decoding processing in the first embodiment (FIG. 6) as follows.

The decoder 18 determines at step S108 whether the number of error intersections is smaller than or equal to a threshold (smaller than or equal to 4, in the above example).

If multiple error intersections are identified, the selection unit 103 selects one of the error intersections at step S109 and selects one or more bits in the selected error intersection.

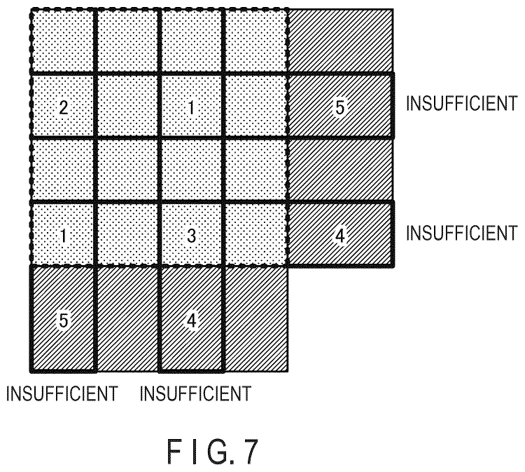

FIG. 7 is a diagram illustrating an example of an error occurrence situation to which this embodiment is applied. In the example in FIG. 7, the syndromes of the component codes in the second and fourth rows and the first and third columns are insufficient, resulting in four error intersections. Because the number of error intersections is smaller than or equal to the threshold (smaller than or equal to 4), the process in this embodiment inverts the values of bits in an error intersection and further performs the decoding with the outer code.

### Third Embodiment

The total number of inversion patterns depends on the maximum error intersection (block) size and the correction ability of the outer code. For example, it is assumed that the error intersection size is 15 bits, and the correction ability of the outer code is 4 bits. Correcting 15 bits at the maximum requires attempting patterns of inversions up to 11 bits (=15 bits-4 bits of the correction ability of the outer code) at the maximum. The total number of patterns of inversions of 1 to 11 bits is the total sum of ₁₅Cₖ (the number of combinations of k bits selected from 15 bits) for k=1 to 11, which is 32191.

For such a large number of patterns, attempting all the patterns may impose an excessive decoding processing load and cause delay. Attempting only some of the patterns for reducing the load will increase the possibility of failed decoding.

The following embodiment describes a technique of reducing the total number of patterns to be attempted. This can increase the efficiency and accuracy of decoding. Specifically, this embodiment involves additional processing of inverting all the bits in the error intersection (hereinafter referred to as all-bit inversion) and then inverting selected bits.

For example, the decoder 18 performs the decoding processing DEC1 for all the patterns in the same manner as in the above embodiment (either the first embodiment or the second embodiment). If the decoding processing DEC1 for all the patterns fails, the decoder 18 inverts all the bits in the error intersection and further performs decoding in the same manner as in the above embodiment.

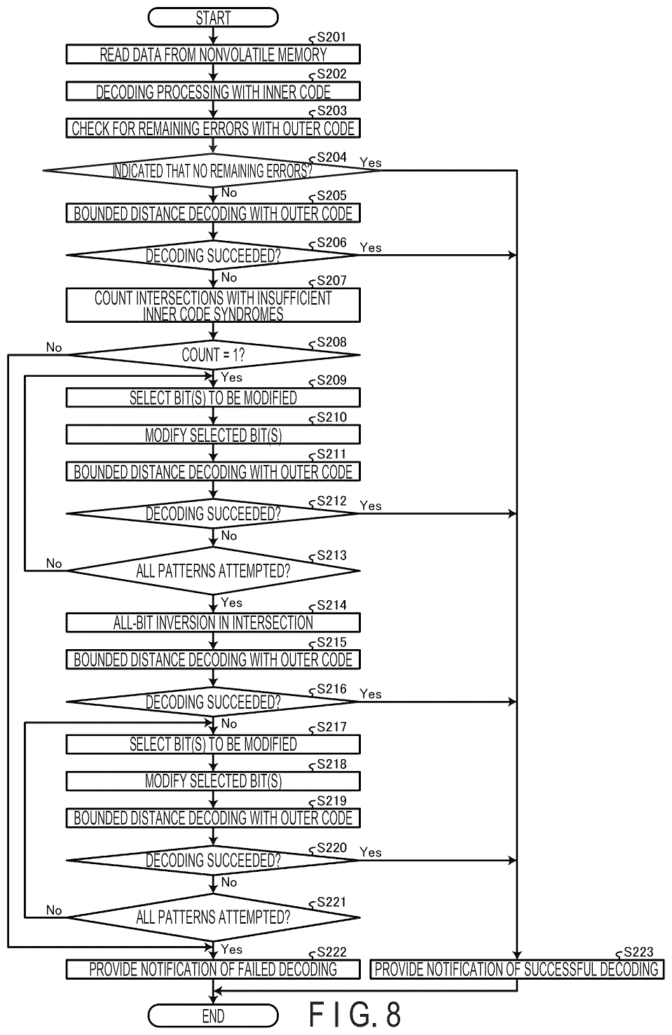

FIG. 8 is a flowchart illustrating an example of decoding processing in a third embodiment. The decoding processing in this embodiment differs from the decoding processing in the first embodiment illustrated in FIG. 6 in that steps S214 to S221 are added. Although the example in FIG. 8 represents a modification to the first embodiment, a similar modification may also be made to the second embodiment.

Steps S201 to S213 are the same as steps S101 to S113 in FIG. 6.

In this embodiment, if all the patterns have been attempted (step S213: Yes), the decoder 18 performs all-bit inversion in the error intersection (step S214) and further performs the decoding processing DEC1 (step S215). The decoder 18 determines if the decoding in the decoding processing DEC1 succeeds (step S216).

If it is determined that the decoding in the decoding processing DEC1 fails (step S216: No), the decoder 18 performs, in steps S217 to S221, the same process as steps S209 to S213 using the error intersection subjected to all-bit inversion.

If it is determined at step S221 that all the patterns have been attempted (step S221: Yes), the decoder 18 provides notification of failed decoding to a destination such as an external control unit (step S222) and terminates the decoding processing.

If it is determined that the decoding in the decoding processing DEC1 succeeds (step S216: Yes, or step S220: Yes), the decoder 18 provides notification of successful decoding and a decoded word to a destination such as an external control unit (step S223) and terminates the decoding processing.

Although FIG. 8 illustrates performing the processing without all-bit inversion (steps S209 to S213) before performing the processing with all-bit inversion (steps S214 to S221), this processing order may be reversed.

Thus, in this embodiment, the modification processing for modifying selected bits includes the modification processing for modifying bits without inverting the bits in the error intersection (first processing, steps such as S210) and the modification processing for modifying bits after inverting the bits in the error intersection (second processing, steps such as S218).

Incorporating all-bit inversion can reduce the total number of patterns to be attempted. For example, letting I be the error intersection size and t be the correction ability of the outer code, the maximum value J of the number of bits to be inverted can be obtained as an integer that satisfies J 2 max (floor (I/2)−t, 0).

For example, if the error intersection size is 15 bits and the correction ability of the outer code is 4 bits, floor (I/2)−t=floor (15/2)−4=3 and hence J can be obtained as 3 (bits). Therefore, in this embodiment, correcting 15 bits at the maximum requires attempting patterns of inversions up to 3 bits at the maximum twice, i.e., for a cycle without all-bit inversion and a cycle with all-bit inversion. The total number of inversion patterns in this case is twice (for the two cycles) the total sum of ₁₅Cₖ for k=1 to 3, which is 1150.

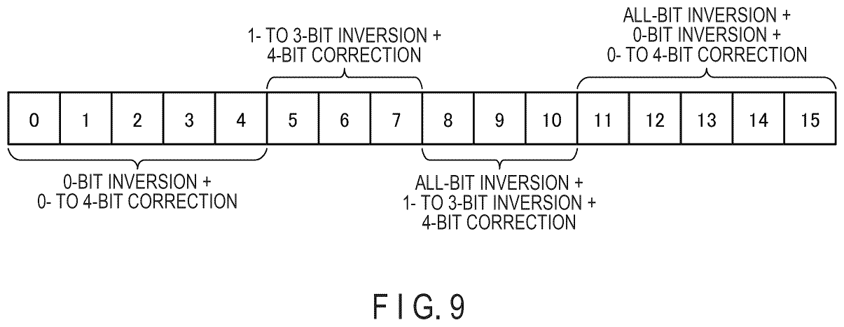

As above, if the error intersection size is 15 bits and the error correction ability of the outer code is 4 bits, setting the maximum value of inversions to 3 (bits) enables all the patterns to be attempted, that is, enables all the errors up to 15 bits to be corrected. FIG. 9 is a diagram illustrating an example in which all the patterns can be attempted.

The numerical values 0 to 15 indicate the numbers of errors potentially occurring in a 15-bit block. For the numbers of errors from 0 (no errors) to 4 bits, the errors can be corrected without all-bit inversion and without bit inversion (modification), because the numbers of errors are within 4 bits, which is the error correction ability of the outer code. For the numbers of errors from 5 to 7 bits, the errors can be corrected without all-bit inversion, with inversion up to 3 bits at the maximum, and with 4-bit correction by the outer code. For the numbers of errors from 8 to 10 bits, the errors can be corrected with all-bit inversion, with inversion up to 3 bits at the maximum, and with 4-bit correction by the outer code. For the numbers of errors from 11 to 15 bits, the errors can be corrected with all-bit inversion, without bit inversion, and with 4-bit correction by the outer code.

Thus, in this embodiment, the maximum value of bit inversions is determined appropriately based on the error intersection size and the correction ability of the outer code. This enables correcting all the errors up to the maximum size that potentially occur in the error intersection.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A memory system comprising:
a nonvolatile memory that stores a concatenated code including a first error correction code and a second error correction code, the first error correction code being generated with data to be stored, the second error correction code being generated with the first error correction code and being an N-dimensional error correction code in which at least one of symbols constituting the code is protected by N component code groups, N being an integer greater than 1; and
a memory controller configured to:
read information from the nonvolatile memory;
perform, for the information, a second decoding processing with the second error correction code;
in a case that a decoding in the second decoding processing fails, perform, for the information which reflects a correction result of the second decoding processing, a first decoding processing with the first error correction code;
in a case that a decoding in the first decoding processing fails, identify an intersection of component codes that are in two or more respective different dimensions and each include an error; and
perform a modification processing for modifying a symbol in the intersection and further perform the first decoding processing.

2. The memory system of claim 1, wherein
in a case that the memory controller identifies intersections fewer than or equal to a threshold number, the memory controller is further configured to modify a symbol in an intersection and further perform the first decoding processing.

3. The memory system of claim 1, wherein
the symbols are bits, and
the modification processing comprises a first processing for modifying a bit in the intersection without inverting the bit, and a second processing for modifying a bit in the intersection after inverting the bit.

4. The memory system of claim 3, wherein
a maximum value J of a number of bits to be inverted satisfies J≥max (floor (I/2)−t, 0), where I is a size of the intersection and t is a correction ability of the first error correction code.

5. The memory system of claim 1, wherein
the memory controller identifies the intersection using feature information indicating a correctness of a correction made with the second error correction code.

6. The memory system of claim 5, wherein
the feature information includes information indicating syndromes of component codes in the N component code groups.

7. The memory system of claim 5, wherein
the feature information includes reliability information indicating degrees of correctness of results of correction made with component codes in the N component code groups.

8. The memory system of claim 1, wherein
the first error correction code and component codes in the N component code groups are each a Bose-Chaudhuri-Hocquenghem (BCH) code.

9. The memory system of claim 1, wherein
the first error correction code and component codes in the N component code groups are each a Reed-Solomon (RS) code.

10. The memory system of claim 1, wherein
in a case that the decoding the second decoding processing succeeds, the memory controller is further configured to output a notification of successful decoding, and
in a case that the decoding the first decoding processing succeeds, the memory controller is further configured to output the notification of successful decoding.

11. A memory controller comprising:
circuitry configured to:
read information from a nonvolatile memory which stores a concatenated code including a first error correction code and a second error correction code, the first error correction code being generated with data to be stored, the second error correction code being generated with the first error correction code and being an N-dimensional error correction code in which at least one of symbols constituting the code is protected by N component code groups, N being an integer greater than 1;
perform, for the information, a second decoding processing with the second error correction code;
in a case that a decoding in the second decoding processing fails, perform, for the information which reflects a correction result of the second decoding processing, first decoding processing with the first error correction code;
in a case that a decoding in the first decoding processing fails, identify an intersection of component codes that are in two or more respective different dimensions and each include an error; and
perform a modification processing for modifying a symbol in the intersection and further performs the first decoding processing.

12. The memory controller of claim 11, wherein
in a case that the memory controller identifies intersections fewer than or equal to a threshold number, the memory controller is further configured to modify a symbol in an intersection and further perform the first decoding processing.

13. The memory controller of claim 11, wherein
the symbols are bits, and
the modification processing comprises a first processing for modifying a bit in the intersection without inverting the bit, and a second processing for modifying a bit in the intersection after inverting the bit.

14. The memory controller of claim 13, wherein
a maximum value J of a number of bits to be inverted satisfies J≥max (floor (I/2)−t, 0), where I is a size of the intersection and t is a correction ability of the first error correction code.

15. The memory controller of claim 11, wherein
the memory controller identifies the intersection using feature information indicating a correctness of a correction made with the second error correction code.

16. The memory controller of claim 15, wherein
the feature information includes information indicating syndromes of component codes in the N component code groups.

17. The memory controller of claim 15, wherein
the feature information includes reliability information indicating degrees of correctness of results of correction made with component codes in the N component code groups.

18. The memory controller of claim 11, wherein
the first error correction code and component codes in the N component code groups are each a Bose-Chaudhuri-Hocquenghem (BCH) code.

19. The memory controller of claim 11, wherein
the first error correction code and component codes in the N component code groups are each a Reed-Solomon (RS) code.

20. A control method comprising:
reading information, from a nonvolatile memory which stores a concatenated code including a first error correction code and a second error correction code, the first error correction code being generated with data to be stored, the second error correction code being generated with the first error correction code and being an N-dimensional error correction code in which at least one of symbols constituting the code is protected by N component code groups, N being an integer greater than 1;
performing, for the information, a second decoding processing with the second error correction code;
in a case that a decoding in the second decoding processing fails, performing, for the read information which reflects a correction result of the second decoding processing, first decoding processing with the first error correction code;
in a case that a decoding in the first decoding processing fails, identifying an intersection of component codes that are in two or more respective different dimensions and each include an error; and
performing a modification processing for modifying a symbol in the intersection and further performs the first decoding processing.
